(19) United States
(12) Patent Application Publication
(10) Pub. No.: US 2005/0278983 A1
(43) Pub. Date: Dec. 22, 2005

(54) Filter vent for drying cabinet

(75) Inventor: Don J. Rydberg, Ankeny, IA (US)

Correspondence Address: MCKEE, VOORHEES & SEASE, P.L.C.;ATTN: MAYTAG, 801 GRAND AVENUE, SUITE 3200, DES MOINES, IA, 50309-2721, US

(73) Assignee: Maytag Corporation, Newton, IA (US)

(21) Appl. No.: 10/791,522

(22) Filed: Mar. 1, 2004

(51) Int. Cl. D06F 71/34; F26B 11/02

(52) U.S. Cl. 38/14

(57) ABSTRACT

A filter vent device is provided for a cabinet dryer having a steam generator for supplying steam to the drying chamber. A water reservoir supplies water to the steam generator via a water hose. The filter vent device is disposed in the water reservoir or tank and includes a water passage with a filter to prevent foreign particles or matter from passing into the hose, thereby preventing clogging. The filter vent device also includes an air passage to allow the escape of air from the water hose, thereby preventing vapor lock. The filter vent device is removably mounted in the water reservoir or tank and has a one-piece construction.

### BACKGROUND OF THE INVENTION

Cabinet dryers are known in the art, but are more popular in Japan than in the United States. Generally, cabinet dryers provide hot air for drying clothes hanging in the cabinet. Steam may be provided to the drying cabinet for de-wrinkling clothes. The drying cabinet includes a water reservoir with a hose or line leading to a steam generator which functions automatically during operation of the dryer to provide steam to the clothes. One problem which may arise in such a steam drying cabinet is clogging or plugging of the water line or the valve in the line which controls the supply of water from the reservoir to the steam generator. Also, due to the low pressure condition in the water line, there is a potential for a vapor lock.

Therefore, a primary objective of the present invention is the provision of a filter vent for the steam generation system of a cabinet dryer.

Another objective of the present invention is the provision of an improved steam generation system for a cabinet dryer.

Another objective of the present invention is the provision of a combination filter vent assembly to prevent clogging and vapor lock in a water line.

Still another objective of the present invention is the provision of a filter vent assembly which is integrally formed as one piece.

Another objective of the present invention is the provision of a filter vent assembly which is removably mounted in the steam generation system of a cabinet dryer.

Yet another objective of the present invention is the provision of a cabinet dryer having a steam generator with a filter vent that is economical to manufacture and effective in use.

These and other objectives will become apparent from the following description of the invention.

### SUMMARY OF THE INVENTION

A combination filter vent assembly is provided for a cabinet dryer. The assembly includes a body with a water passage through which water flows from the water reservoir in the dryer to the hose which directs the water to the steam generator. A filter is formed in the body to prevent the water line from becoming plugged or clogged with foreign matter. An air passage is also formed in the body to allow air to escape from the water line, and thereby prevent vapor lock. The filter vent body is molded as one piece such that the water and air passages and filter have an integral construction. The filter vent is removably mounted in the water tank of the cabinet dryer.

### BRIEF DESCRIPTION OF THE DRAWINGS

FIG. 1 is a perspective view of a combination tumble and cabinet dryer with a steam generator and the filter vent of the present invention.

FIG. 2 is a perspective view of the steam generation system of the dryer, and having the filter vent of the present invention.

FIG. 3 is a sectional view along lines 3-3 of FIG. 2.

FIG. 4 is a perspective view of the filter vent of the present invention.

FIG. 5 is a sectional view taken along lines 5-5 of FIG. 4.

### DETAILED DESCRIPTION OF THE PREFERRED EMBODIMENT

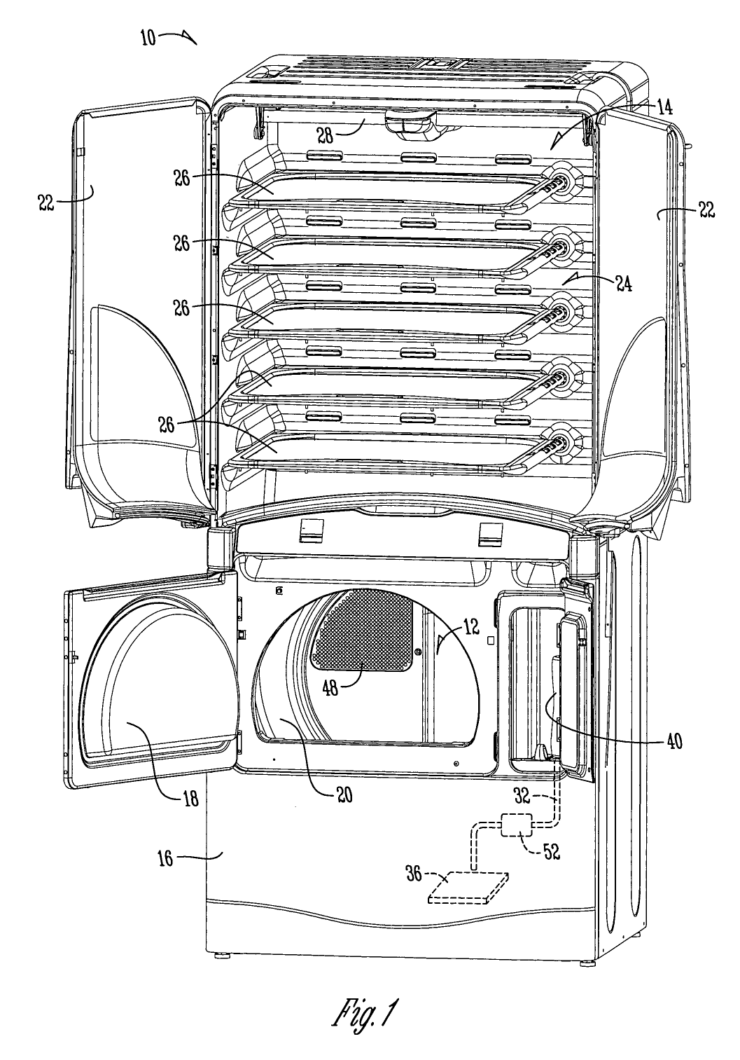

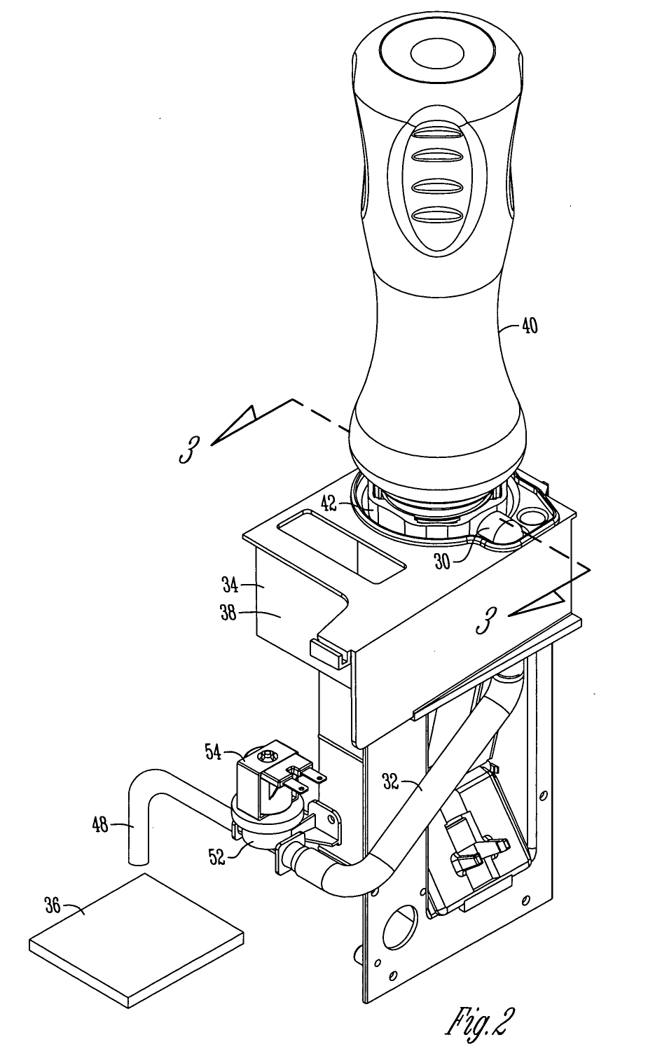

FIG. 1 shows a combination clothes drying machine 10 having a tumble dryer 12 and a drying cabinet 14. The tumble dryer 12 and cabinet dryer 14 are housed within a cabinet or housing 16 so as to define a single appliance with dual functions. The drying cabinet is shown to be mounted on top of the tumble dryer 12, though it is understood that other configurations may be provided. The tumble dryer 12 includes a door 18 so as to provide access to a rotatable drum 20. The cabinet dryer 14 includes a pair of doors 22 to provide access to a drying compartment 24. The drying compartment 24 includes removable shelves 26, which preferably have a mesh support surface so that air can circulate therethrough and a hanging bar 28 to hold clothes on hangers. The shelves 26 are removable so that clothes on hangers can be supported on the bar 28 substantially across the width of the cabinet dryer 14.

Independent hot air systems are provided for the tumble dryer 12 and cabinet dryer 14. The details of the hot air system are described in Applicant's co-pending applications with Ser. No. 10/406,814 filed on Apr. 4, 2003 and Ser. No. 10/361,896 filed on Feb. 10, 2003, and incorporated herein by reference.

The machine 10 includes controls to separately operate the independent hot air supply systems for either or both of the tumble and cabinet dryers 12, 14. Accordingly, the tumble dryer 12 and the cabinet dryer 14 can be operated independently of one another, either simultaneously or one at a time.

The present invention is directed towards a filter vent device 30 which is used in the steam generation system of the cabinet dryer 14 to prevent clogging and vapor lock in the water line 32 which extends between a water reservoir 34 and a steam generation plate 36. The water reservoir 34 is a cup or tank 38 adapted to hold a water bottle 40 with a removable cap 42. The cap 42 includes an opening 44 to allow water to flow from the bottle 40 into the reservoir 34.

The water line 32 includes an upper inlet end 46 operatively connected to a spout 47 extending downwardly on the water tank 38 and a lower outlet end 48 positioned above the steam plate 36 which is heated in a conventional manner to generate steam as water drips onto the plate 36. A valve 52 in the water line 32 controls the flow of water from the tank 38 to the steam plate 36. The valve 52 moves between open and closed position, as controlled by a solenoid 54 which functions automatically during the drying cycle of the cabinet dryer 14.

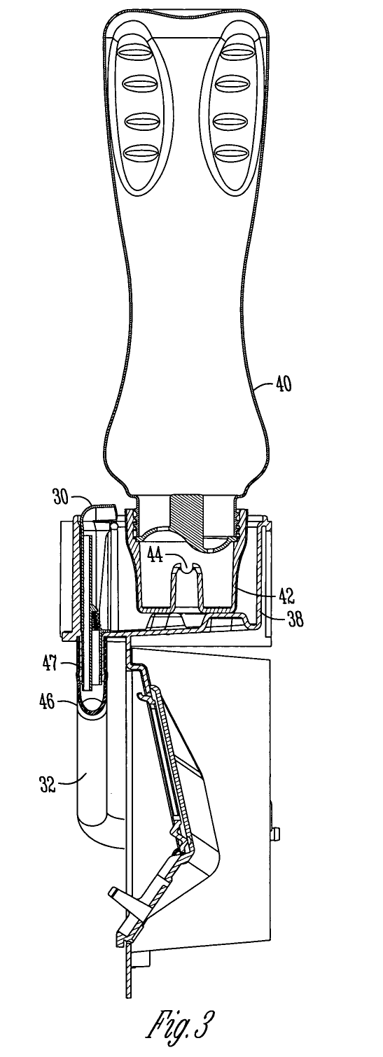

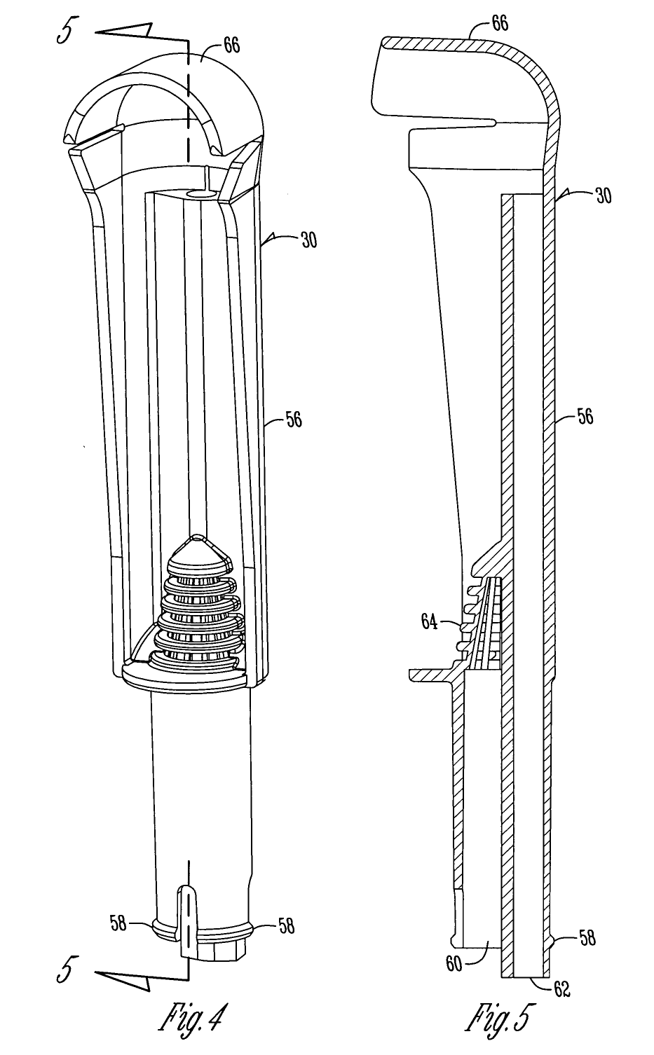

The filter vent device 30 of the present invention is removably mounted in the spout 47 of the tank 38, as best seen in FIG. 3. The lower end of the filter vent device 30 includes a circumferential rib 58 which snaps beneath the lower end of the spout 47 to permit removable mounting of the device 30 in the spout 47. The filter vent device 30 includes a body 56 having a water passage or channel 60 and an air passage 62 formed therein. A filter 64 is formed at the upper end or inlet of the water passage 60 to prevent foreign particles from flowing into the water passage 60 and the water line 32. The filter vent device 30 is molded plastic such that the body has an integral, one-piece construction.

In operation, when the valve 52 is open, water from the tank 38 flows via gravity through the filter 64 and downwardly through the water passage 60 into the water line 32, and then to the steam plate 36. Air in the water line 32 will escape through the air passage 62 which extends above the water level in the tank 38. A hood 66 is provided on the upper end of the body 56 to provide easy grasping so that a user can remove the device 30 from the water line 32 and clean the filter 64. The device 30 can then be snapped back into place with the tab 58 securing the device 30 in the water tank 38.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. A combination filter vent device for directing liquid from a tank to a hose, comprising:
a body having a liquid passage through which liquid flows from the tank to the hose and an air passage through which air flows from the hose to the tank; and
a filter in the liquid passage.

2. The device of claim 1 wherein the filter is integrally formed in the body.

3. The device of claim 1 wherein the body and filter are molded as one piece.

4. The device of claim 1 wherein the body has a lower end adapted to fit into the tank.

5. The device of claim 1 wherein the body has a lower end with a plurality of resilient tabs adapted for mounting the body to the tank.

6. A clothes dryer, comprising:
a drying chamber;
a steam generator for supplying steam to the drying chamber;
a water source for supplying water to the steam generator;
a hose extending between the water source and the steam generator; and
a body mounted to the water source having an air vent and a water filter therein.

7. The clothes dryer of claim 6 wherein the body has a first passage defining the air vent and a second passage defining a water channel, and the filter is associated with the water channel.

8. The clothes dryer of claim 7 wherein the first passage extends upwardly to allow air to pass therethrough and the second passage extends downwardly to allow water to flow by gravity therethrough.

9. The clothes dryer of claim 7 wherein the body is a molded piece with the passages formed therein.

10. The clothes dryer of claim 7 wherein the water channel has an inlet and the filter covers the inlet.

11. The clothes dryer of claim 10 wherein the air vent has an outlet residing above the inlet of the water channel.

12. The clothes dryer of claim 6 wherein the body is a molded piece with the filter formed therein.

13. The clothes dryer of claim 6 wherein the body is a molded piece with the vent and filter formed therein.

14. The clothes dryer of claim 6 wherein the body has a lower end to mount to the water source.

15. The clothes dryer of claim 14 wherein the lower end has at least one resilient tab to mount the body to the water source.

16. The clothes dryer of claim 6 wherein the body snap fits to the water source.

17. The clothes dryer of claim 6 further comprising a valve in the hose movable between an open position to allow water from the water source to flow to the steam generator and a closed position to prevent water from flowing from the water source to the steam generator.

18. The clothes dryer of claim 17 wherein the valve is automatically moved between the open and closed positions during operation of the dryer.

19. The clothes dryer of claim 17 further comprising a solenoid switch to control movement of the valve between the open and closed positions.

20. The clothes dryer of claim 6 wherein the body is removably mounted to the water source.
